(19) United States
(12) Patent Application Publication
(10) Pub. No.: US 2013/0313179 A1
(43) Pub. Date: Nov. 28, 2013

(54) Filter Head, Filter Element, Mounting Device and Filter Arrangement

(71) Applicant: MANN+HUMMEL GMBH, Ludwigsburg (DE)

(72) Inventor: Christian Kocksch, Roemerberg (DE)

(73) Assignee: MANN+HUMMEL GMBH, Ludwigsburg (DE)

(21) Appl. No.: 13/899,823

(22) Filed: May 22, 2013

(30) Foreign Application Priority Data
May 24, 2012 (DE) 10 2012 010 242.9

(51) Int. Cl. B01D 35/30

(52) U.S. Cl. CPC B01D 35/306
USPC 210/232; 29/700; 29/428

(57) ABSTRACT

A filter head for a screw-on filter element has a filter head body and a coupling section that is supported on the filter head body so as to be rotatable about a longitudinal axis of the filter head body. The coupling section has at least one first receptacle that receives a blocking element of a mounting device connected to a filter element. The blocking element is inserted in a direction of the longitudinal axis of the filter head into the first receptacle. The blocking element, when inserted in the first receptacle, blocks a rotation of the coupling section relative to the filter head body so that the filter element can be screw-connected to the filter head.

### CROSS REFERENCE TO RELATED APPLICATIONS

This application claims priority to German patent application no. 10 2012 010 242.9 filed May 24, 2012, the entire contents of which are hereby incorporated by reference.

### BACKGROUND OF THE INVENTION

The invention concerns a filter head, a filter element, a mounting device, and a filter arrangement. Filter devices are often used as a combination of a filter head, used for connection to a conduit system and provided e.g. with valves, and a filter element that can be coupled to the filter head.

So-called spin-on filters are known that are coupled by means of a screw connection to or with a filter head. Known are spin-on filters e.g. for filtering operating media in motor vehicles, such as oil, fuel or the like. In such filters, a connecting thread, for example, an inner thread, in a filter cover that closes off a filter cup is used for screwing the filter cover onto the filter head provided with a counter thread. The filter head provided with fittings, connectors or valves is then in communication with the filter medium in the filter cup.

It is in particular desirable to exchange a spent or clogged filter; in this context, faulty operations or the exchange for an unsuitable replacement filter is to be prevented. In all combinations of filter heads and filter elements, a certain predetermination with respect to suitable filter element/filter head combinations is possible generally only by selection of the threads on the filter head connector and the filter element connector.

### SUMMARY OF THE INVENTION

It is therefore an object of the present invention to provide alternative or improved filter heads or filter elements. In particular, a simple manipulation is to be provided and the exchange for or replacement with unsuitable filter elements is to be prevented.

Accordingly, a filter head is proposed which comprises a filter head body and a coupling section. The coupling section is supported on the filter head body so as to be rotatable about a longitudinal axis of the filter head and the coupling section comprises at least a first receptacle for a blocking element, insertable in the direction of the longitudinal axis, for blocking a rotation of the coupling section relative to the filter head body.

The filter head is particularly suitable to be coupled with a filter element that can be screwed on, such as a spin-on filter. The filter head is suitable, for example, for coupling with a filter element which can be coupled to the filter head by rotation about the longitudinal axis. In this context, the filter element can be screwed on or can be connected by different suitable mechanisms, for example, a bayonet closure, with the filter head. Preferably, the coupling action is realized so as to provide a fluid-tight connection. The coupling section can be constructed of several parts but can also be a single element.

As a result of the rotatable support of the coupling section, which is preferably exclusively counteracted by the insertable blocking element, it is possible to connect only predetermined, properly matched filter elements to the filter head. Means for fluid-tight connection of the filter element to be screwed on are provided, for example, on the coupling section. The means can be e.g. thread sections or other known couplings that, by rotation about the longitudinal axis or rotational axis of filter head and/or the filter element, generate a coupling action. The rotational axis is e.g. a symmetry axis of the filter element that is preferably of rotational symmetry. Without a blocking element being inserted, the coupling section will spin freely on the filter head body so that a filter element cannot be screwed onto the filter head or cannot be coupled in a proper way.

In the embodiment, the filter head comprises moreover at least a second receptacle for the blocking element that is insertable in the direction of the longitudinal axis.

By means of a suitable blocking element, for example, a tongue, a peg or a pin, the first receptacles and the second receptacles can be connected to each other so as to be rotationally fixed relative to each other (anti-rotation connection) so that the coupling section as a whole no longer can rotate relative to the filter head body. The blocking elements can be arranged, for example, on a filter element or a mounting device. As a receptacle, grooves are conceivable, for example, but holes or openings can be provided also. A receptacle can also be of a polygonal geometry so that, in accordance with the lock-and-key principle, the blocking elements can engage compatibly the receptacles of the coupling section and of the filter head body only when they have the same basic geometry.

In further embodiments of the filter head, the first receptacle and the second receptacle can be arranged in alignment with each other by means of the blocking element for blocking the rotation of the coupling section relative to the filter head body. For example, the first and second receptacles which can be embodied as grooves can be positioned in alignment with each other and can then be coupled with each other with positive fit by means of the blocking element, for example, embodied like a tongue or a pin, that engages both the first receptacle and the second receptacle aligned with each other.

It is conceivable that several first receptacles and several second receptacles are disposed along a peripheral line about the longitudinal axis. Moreover, the at least one first receptacle can have an insertion aid for blocking elements. For example, the receptacle can be designed as an opening with a tapering cross-section.

Moreover, a mounting device, in particular for a filter element, such as a spin-on filter, is proposed for use on a filter head. The filter head comprises in this context preferably a filter head body and a coupling section which is rotatably supported on the filter head body about a longitudinal axis of the filter head wherein the coupling section has at least one first receptacle for a blocking element that is insertable in the direction of the longitudinal axis for blocking a rotation of the coupling section relative to the filter head body. In this context, the mounting device has at least one blocking element which is designed for engaging the receptacle of the coupling section and which preferably can be arranged between a filter head and a filter element. Preferably, the blocking element is designed to engage the first receptacle of the coupling section and the second receptacle of the filter head body, in particular when the first and second receptacles are aligned with each other.

The mounting device can also be understood as an adapter device for a filter head of the kind described above. In this context, the mounting device fulfills the function of fixation or blocking of the components of the filter head that are rotatable relative to each other, i.e., the coupling section and the filter head body.

In an embodiment variant of the mounting device, the mounting device is embodied as a sleeve which comprises blocking elements that are oriented radially in inward direction. The sleeve is preferably designed such that it surrounds the coupling section at least partially in certain mounting states. The mounting device can be embodied, for example, to be pushed onto the coupling section.

Moreover, the mounting device can be provided with a radial seal and/or an axial seal (axial and radial being defined relative to the longitudinal axis). The seals can moreover be provided on the filter head. For example, by means of O-rings as seals, a reliable sealing action between filter head, filter element and mounting device can be additionally achieved. It is particularly preferred that on the coupling section a seal is provided that seals in radial direction outwardly and is in seal-tight contact with the mounting device and separates the raw side from the clean side in this way.

Moreover, a filter element is provided which is suitable for coupling on a filter head comprising a filter head body and a coupling section. Here, the coupling section is rotatably supported about the longitudinal axis on or in the filter head body wherein the coupling section comprises at least one receptacle for a blocking element insertable in the direction of the longitudinal axis for blocking a rotation of the coupling section relative to the filter head body. The filter element is provided with a mounting device which is supported on the filter element so as to be rotatable about the longitudinal axis of the filter head/filter element. The mounting device has in this context at least one blocking element which is designed for engagement of the receptacle of the coupling section.

The mounting device can be secured so as to be rotatable, for example, on a terminal disk of a spin-on filter. Since the mounting device is provided together with the (e.g. projecting) blocking element in a rotatable manner on the filter cover, the filter element, even when the coupling section is locked on the filter head body, can be safely screwed onto the filter head by means of the blocking elements.

Finally, a filter arrangement with a filter head and a filter element is proposed. In this connection, the filter element and the filter head are connectable with each other by a screwing action about the longitudinal axis. The filter head and the filter element are preferably designed as described above.

In the embodiment of the filter arrangement, the blocking elements are designed such that the blocking elements block rotation of the coupling section relative to the filter head body in a mounting state in which the filter element is placed onto the filter head but not yet fluid-tightly coupled with the filter head.

In this way, it can be prevented that third-party origin and unsuitable filter elements, not provided with an appropriate mounting device, can be coupled to the filter head. This is so because, without the mounting device that prevents rotation of the coupling section relative to the filter head body, the coupling means that are to be coupled with each other by rotation cannot fixedly and operatively engage each other to realize a fluid-tight coupling action.

Further possible implementations of the invention comprise also combinations, not explicitly mentioned, of features and embodiment variants, described above or in the following, of the filter head, the filter element, the mounting device or the filter arrangement. In this context, a person of skill in the art will also add or modify individual aspects as improvements or supplements of the respective basic form of the invention.

Further embodiments of the invention are the subject matter of the dependent claims as well as of the embodiments of the invention described in the following. The invention will be explained in more detail in the following with the aid of embodiments with reference to the attached Figures.

### BRIEF DESCRIPTION OF THE DRAWING

FIG. 1 shows a perspective view of an embodiment of a filter arrangement.

FIG. 2 shows a cross-sectional view of a detail of the filter arrangement of FIG. 1 in the assembled state.

FIG. 3 is a perspective section view of the coupling area between the filter head and the filter element of the filter arrangement of FIG. 1 for explaining the mounting process.

FIG. 4 is another perspective section view of the coupling area between the filter head and the filter element of the filter arrangement of FIG. 1 for explaining the mounting process.

FIG. 5 is a perspective view of an embodiment of the filter element provided with a mounting device.

FIG. 6 is a cross-sectional view of a detail of a further embodiment of a filter arrangement in the assembled state.

FIG. 7 is a perspective view of a coupling area between the filter head and a filter element of the filter arrangement of FIG. 6 for explaining a mounting process.

FIG. 8 is another perspective view of the coupling area between the filter head and the filter element of the filter arrangement of FIG. 6 for explaining the mounting process.

FIG. 9 is another perspective view of the coupling area between the filter head and the filter element of the filter arrangement of FIG. 6 for explaining the mounting process.

FIG. 10 is a perspective section view of the coupling area between the filter head and the filter element of the filter arrangement of FIG. 6 for explaining the mounting process.

FIG. 11 is another perspective section view of the coupling area between the filter head and the filter element of the filter arrangement according to FIG. 6 for explaining the mounting process.

FIG. 12 is a perspective view of an embodiment of a mounting device.

FIG. 13 is a plan view of an embodiment of a mounting device.

In the Figures, same reference characters identify same or functionally the same elements, inasmuch as nothing to the contrary is indicated.

### DESCRIPTION OF THE PREFERRED EMBODIMENTS

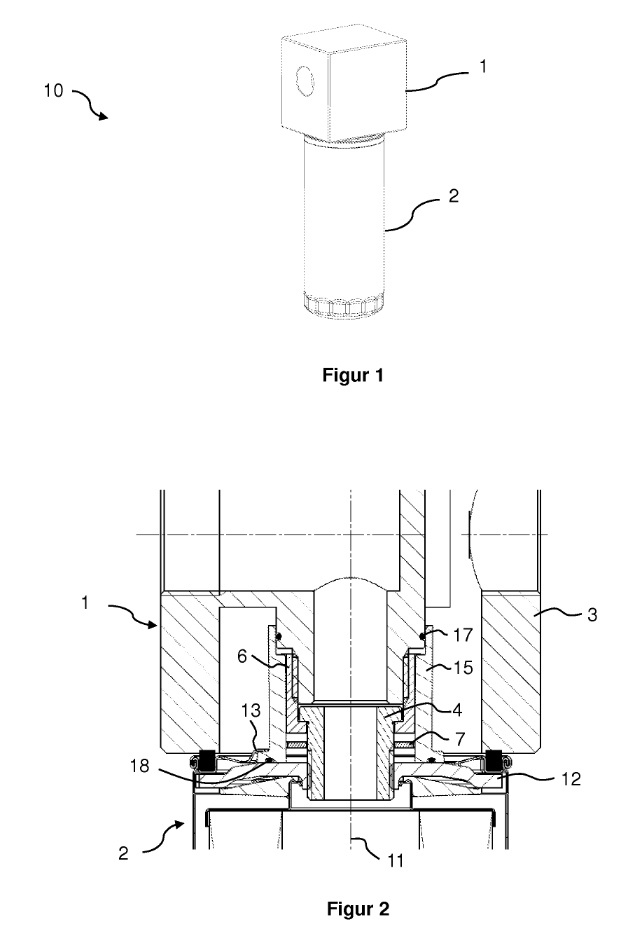

FIG. 1 shows a perspective view of an embodiment of a filter arrangement. The filter arrangement 10 comprises a filter head 1 and a filter element 2 coupled to the filter head 1. The filter head 1 comprises e.g. passages, overpressure valves or fixtures (these elements not being illustrated here) for coupling to a fluid circulation. The fluid circulation can be, for example, an oil circuit or other operating medium circuit in motor vehicles or machines. The filter element is in particular designed as a spin-on filter, i.e., can be attached by rotation about its longitudinal axis with the filter head. Detailed illustrations of the coupling area between the filter element 2 and the filter head 1 are shown in FIGS. 1 to 5.

The embodiment of the filter head 1 comprises a filter head body 3. The filter head body 3 can be designed of injection-molded material, for example, plastic material but also metal. On or in the filter head 1 a coupling section 4 is provided which has an outer thread 14 in the direction pointing toward the filter element 2 to be coupled. In the embodiment of FIGS. 1 through 5, the filter element is designed as a spin-on filter. The filter element 2 comprises a filter cup that is provided with a cover 12 which, in turn, is provided with an inner thread 16. The inner thread 16 is embodied to match the outer thread 14 of the coupling section 4 of the filter head 1. Accordingly, in principle the filter element 2 and the filter head 1 can be coupled with each other in that they are combined coaxially with each other in the direction of their longitudinal axis 11 and then screwed together.

So that only suitable combinations of filter heads 1 and filter elements 2 can be connected to each other, the coupling section 4 which is arranged like a sleeve on the filter head body 3 is rotatably supported. For example, the detail view of FIG. 5 shows that the coupling section 4 is rotatably arranged concentric to the connecting element 6 in a positive fit connection. The connecting element 6 is provided on its inner side with inner thread 19 that can interact with an outer thread 20 provided on the filter head body 3. The attachment or connecting element 6 is connected fixedly to the filter head body 3.

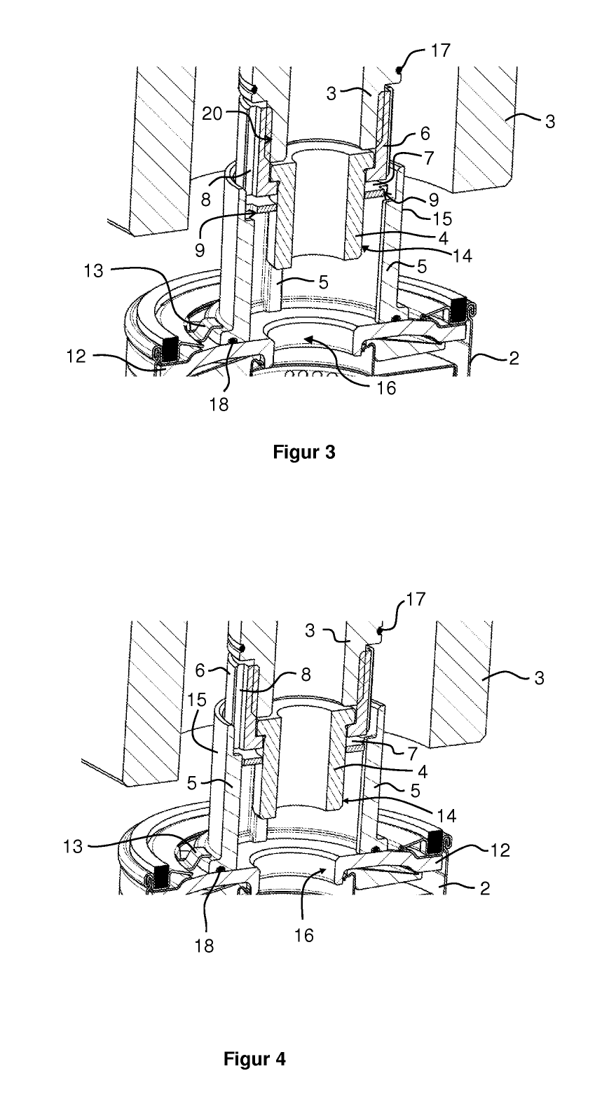

Moreover, a centering disk 7 with cutouts 9 distributed about its circumference is arranged fixedly, or at least so as be rotationally fixed, on the coupling section 4. In the demounted state, as shown in FIG. 3, the coupling section 4 can rotate freely about the longitudinal axis 11 of the filter head 1. Accordingly, the outer thread 14 is not fixed and, when attempting to screw in the inner thread 16 of the filter element 2, would not engage. So that suitable filter elements can be coupled to the appropriate filter head 1, the filter elements are provided with a mounting aid or mounting device at the cover side. The filter element 2 illustrated in FIGS. 1 through 5 has a sleeve-shaped mounting device (sleeve) 15 and the sleeve 15 has at predetermined locations inwardly oriented blocking elements 5. The blocking elements 5 are oriented in radial direction inwardly along the longitudinal axis 11 and embodied as tongues, ribs or webs. Moreover, FIG. 3 shows that on the centering disk 7 cutouts or receiving openings (first receptacles) 9 are provided. In the assembled position, as indicated in FIGS. 3 and 4, they are aligned with second receptacles 8 which are provided as grooves in the connecting element 6. Upon combining, in the direction of the common longitudinal axis 11, the filter element 2 and the filter head 1, as shown in FIG. 4, the blocking elements (tongues) 5 can be inserted into the receiving openings (first receptacles) 9 of the centering disk 7 and the grooves (second receptacles) 8 of the connecting element 6. In this way, a rotation of the coupling section 4 about the longitudinal axis 11 is prevented. Accordingly, the outer thread 14 on the coupling section 4 can operatively engage the inner thread 16 of the filter head cover 12 and a fluid-tight connection between the filter head 1 and the filter element 2 can be realized.

The assembled state is shown in cross-section in FIG. 2. In order to obtain an improved seal-tightness, on the sleeve-shaped mounting device 15 an axial seal 18 is provided which acts on the filter cup cover 12; between the sleeve-shaped mounting device 15 and the outer surface of the connecting element 6 that is also sleeve-shaped a radial seal 17 is provided. The mounting device 15, as shown in FIG. 5, is attached by means of fastening clips 13 on the filter element 2. However, it can also be embodied as an individual mounting device 15 and can first be coupled with the filter head, as shown in FIGS. 2 to 4, in order to prevent the rotation of the coupling section 4 about the longitudinal axis 11.

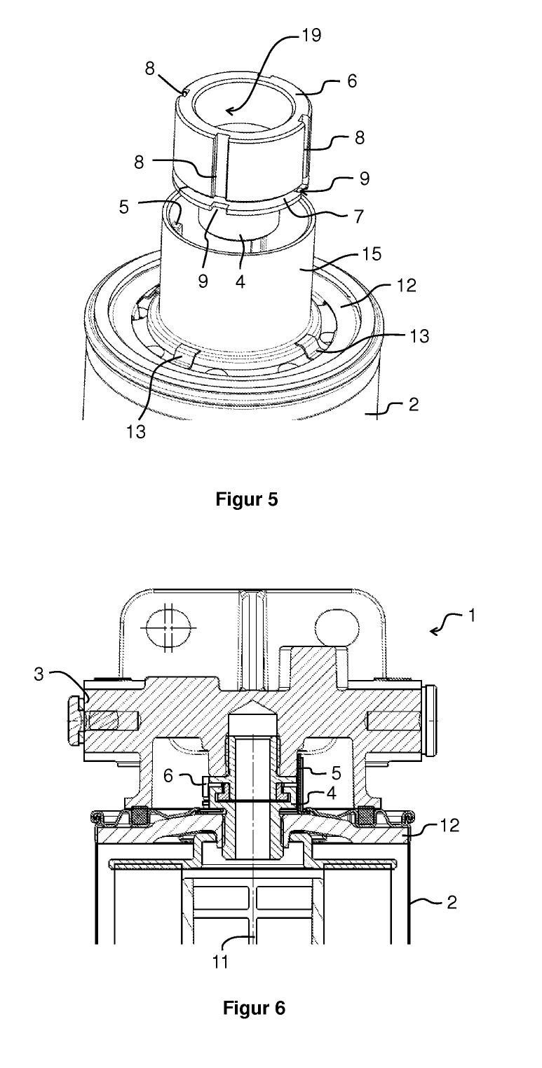

In FIGS. 6 to 11, a further embodiment of a filter arrangement with a filter element, a mounting device and a filter head is illustrated. In the Figures, the same reference characters as in the first embodiment are used for the same components so that no further explanation will be provided here in this context. Instead, the differences relative to the first embodiment will be essentially described.

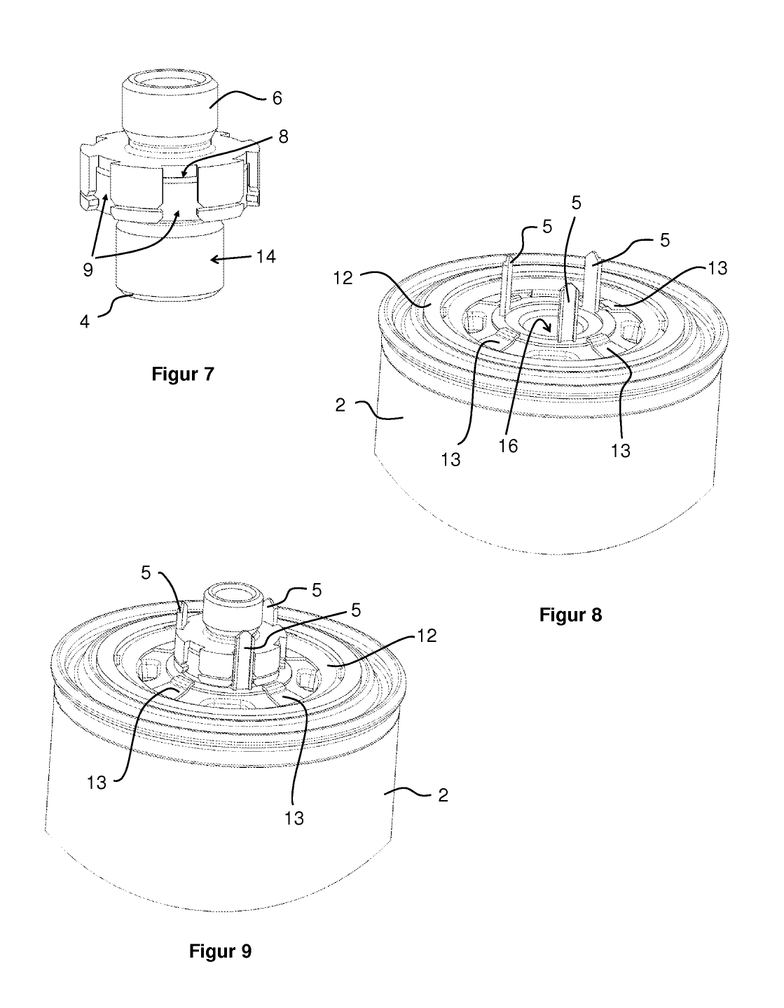

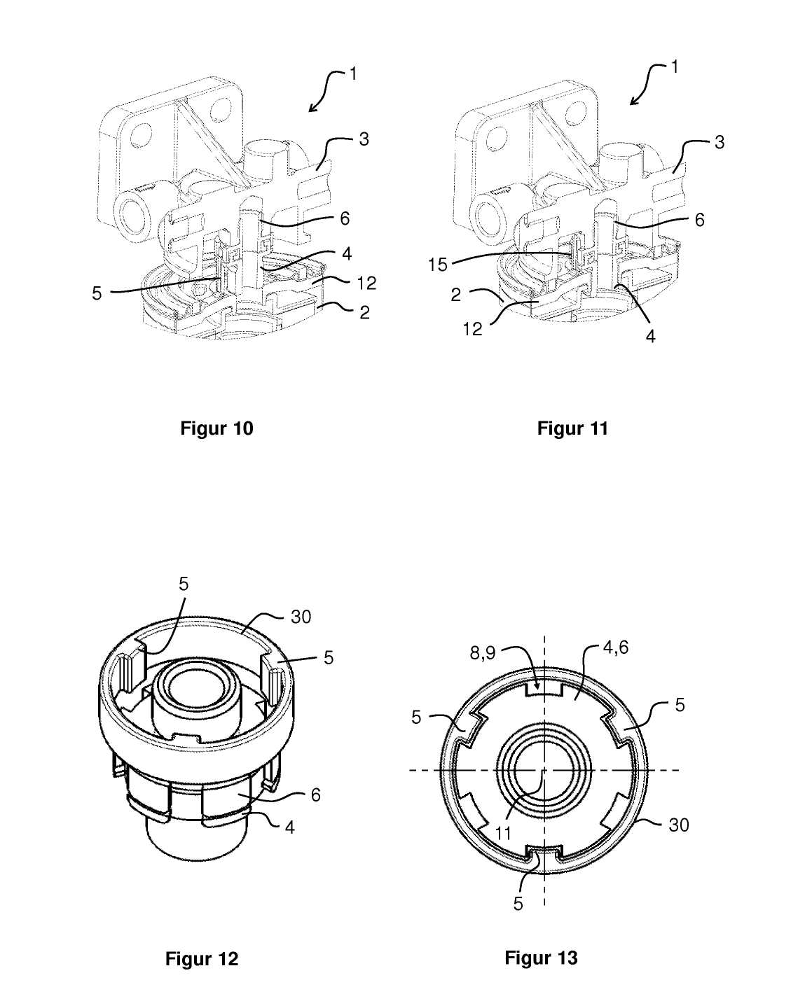

In FIG. 7, a perspective illustration of an embodiment of a coupling section 4 is illustrated that comprises an outer thread 14. Moreover, a connecting element 6 is illustrated that is connected e.g. fixedly with a filter head body. This is illustrated in FIG. 6 and the perspective section views of FIGS. 10 and 11. The connecting element (or fastening element) 6 is rotatable relative to the coupling section 4 or the coupling section 4 can rotate relative to the filter head body 3. Moreover, cutouts (first receptacles) 9 are provided on the coupling section 4 and cutouts (second receptacles) 8 in the form of flat grooves are provided on the connecting element 6. In FIG. 7, the two cutouts 8, 9 are illustrated in alignment with each other and can be secured in their position relative to each other by blocking elements 5. The blocking elements 5 are provided, for example, rotatably on the filter cup cover 12, as illustrated in FIG. 8. In this respect, an embodiment of the mounting device is provided that comprises a perforated disk provided with pins 5 projecting therefrom. The perforated disk is secured by means of clips 13 rotatably on the filter cup cover 12. When, as indicated in FIG. 9, the filter element is placed onto the filter head 1 (compare FIG. 10), the pins 5 engage or project through the openings or grooves 9 and 8. In this way, a rotation of the coupling section 4 relative to the filter body 3 or the connecting element 6 is prevented. Accordingly, an outer thread 14 provided on the coupling section 4 can operatively engage the thread 16 on the filter element 2 and can be screw-connected. This process is indicated in FIGS. 10 and 11. FIG. 11 shows the assembled state.

FIGS. 12 and 13 show a further embodiment of a mounting device. As an alternative to the pins 5 illustrated in FIGS. 8 to 11, a separate mounting device 30 can be provided that is matched to the filter head or the combination of connecting element 6 and coupling section 4, as illustrated in FIG. 7. In FIG. 12, a perspective view of a coupling section 4 and a connecting element 6 is illustrated. As a mounting device 30, a short cylinder wall with inwardly oriented tongues 5 is provided. The mounting device 30 can thus be pushed onto the coupling section 4 and the areas of the connecting element 6, where the cutouts 8, 9 are provided. In the plan view of FIG. 13, it is shown that the tongues 5 engage the grooves or cutouts 8, 9 and a rotation about the longitudinal axis 11 is prevented. For example, an appropriate mounting device 30 in the orientation of FIG. 10 could be pushed from below across the coupling section 4 so that, instead of the pins 5 (compare FIGS. 8 to 11), the tongues 5 engage and prevent a rotation of the coupling section 4 relative to the filter head 3.

The proposed filter arrangements, filter elements, mounting devices and filter heads enabled according to the lock-and-key principle a safe coupling action of filter elements with suitable filter heads. By the proposed combination that can also be referred to as a rotatable filter interface and that comprises a rotatable coupling section and a mounting aid that is rotatably arranged on the filter element, it can be prevented that unsuitable filter elements can be screwed onto a filter head that is, for example, fixedly secured in a motor vehicle. For example, the mounting aids would be provided only to authorized shops so that, for example, filter elements that are not certified cannot be screwed onto the filter head because the coupling section spins freely. In this way, faulty operation or faulty exchange of filter elements is prevented. This improves the safety in regard to operation of filters. Because of the movable arrangement of the coupling sections relative to the filter head body, the latter can be embodied with greater tolerances because in this arrangement less stringent requirements exist with regard to vertical arrangement of the sealing plane of the axial seal relative to the axis of rotation of the mounting thread onto which the filter element or the exchangeable filter are to be screwed. In this way, mounting is facilitated also because mounting can still be realized even when at the start of the assembly a slightly slanted positioning of the filter element exists.

Even though the present invention has been explained with the aid of various embodiments, the invention is not limited thereto but can be modified in multiple ways. For example, connections other than screw connections can be used for coupling the filter to the filter head. In accordance with the respective operational situation and application, appropriately matched materials can be used. Also, the geometries of the filter head and filter element can be matched to the respective installation situation.

While specific embodiments of the invention have been shown and described in detail to illustrate the inventive principles, it will be understood that the invention may be embodied otherwise without departing from such principles.

What is claimed is:

1. A filter head for a screw-on filter element, the filter head comprising:
a filter head body;
a coupling section that is supported on the filter head body so as to be rotatable about a longitudinal axis of the filter head;
wherein the coupling section has at least one first receptacle adapted to receive a blocking element to be inserted in a direction of the longitudinal axis of the filter head, wherein the blocking element, when inserted in the at least one first receptacle, blocks a rotation of the coupling section relative to the filter head body.

2. The filter head according to claim 1, wherein the filter head body has at least one second receptacle adapted to receive the blocking element.

3. The filter head according to claim 2, wherein the at least one first receptacle and the at least one second receptacle are aligned relative to each other by the blocking element.

4. The filter head according to claim 2, wherein several of the at least one first receptacle and several of the at least one second receptacle are distributed along a peripheral line about the longitudinal axis.

5. A mounting device for a filter element for use in a filter head according to claim 1, the mounting device comprising:
at least one blocking element adapted to engage at least one first receptacle of the coupling section of the filter head, wherein the at least one blocking element is adapted to be arranged between the filter head and a filter element.

6. The mounting device according to claim 5, wherein the at least one blocking element is adapted to engage also at least one second receptacle of the filter head body

7. The mounting device according to claim 5, comprising a sleeve, wherein the at least one blocking element is provided on the sleeve and is oriented in radial direction inwardly, wherein the sleeve at least partially surrounds the coupling section when the sleeve is disposed on the filter head.

8. The mounting device according to claim 5, comprising a radial seal arranged radially relative to the longitudinal axis of the filter head.

9. The mounting device according to claim 5, comprising an axial seal arranged axially relative to the longitudinal axis of the filter head.

10. The mounting device according to claim 5, comprising a radial seal arranged radially relative to the longitudinal axis of the filter head and an axial seal arranged axially relative to the longitudinal axis of the filter head.

11. A filter element for coupling to a filter head according to claim 1, the filter element comprising a mounting device comprising at least one blocking element adapted to engage at least one first receptacle of the coupling section of the filter head, wherein the at least one blocking element is adapted to be arranged between the filter head and the filter element, wherein the mounting device is supported on the filter element so as to be rotatable about a longitudinal axis of the filter element.

12. A filter arrangement comprising a filter head according to claim 1 and a filter element, the filter element comprising a mounting device comprising at least one blocking element adapted to engage at least one first receptacle of the coupling section of the filter head, wherein the at least one blocking element is adapted to be arranged between the filter head and the filter element, wherein the mounting device is supported on the filter element so as to be rotatable about a longitudinal axis of the filter element, and wherein the filter element and the filter head are adapted to be screw-connected by rotation about the longitudinal axis.

13. The filter arrangement according to claim 12, wherein the at least one blocking element blocks in a mounted state, in which the filter element is attached to the filter head but is not yet fluid-tightly coupled to the filter head, a rotation of the coupling section relative to the filter head body.

14. A method for mounting a filter element on a filter head according to claim 1, the method comprising the steps of:
arranging a mounting device comprising at least one blocking element on a filter element and supporting the mounting device on the filter element so that the mounting device is rotatable about a longitudinal axis of the filter element;
engaging with the at least one blocking element at least one first receptacle of the coupling section of the filter head, wherein the at least one blocking element is positioned between the filter head and the filter element.
